(19) United States
(12) Patent Application Publication
(10) Pub. No.: US 2023/0299272 A1
(43) Pub. Date: Sep. 21, 2023

(54) COATED ACTIVE MATERIAL

(71) Applicants: TOYOTA JIDOSHA KABUSHIKI KAISHA, Toyota-shi (JP); PANASONIC HOLDINGS CORPORATION, Osaka (JP)

(72) Inventors: Kazuki MURAISHI, Toyota-shi (JP); Masaru KUBOTA, Okazaki-shi (JP); Yusuke NISHIO, Osaka-shi (JP); Kenji NAGAO, Toyota-shi (JP)

(73) Assignees: TOYOTA JIDOSHA KABUSHIKI KAISHA, Toyota-shi (JP); PANASONIC HOLDINGS CORPORATION, Osaka (JP)

(21) Appl. No.: 18/179,690

(22) Filed: Mar. 7, 2023

(30) Foreign Application Priority Data
Mar. 18, 2022 (JP) 2022-043954

(51) Int. Cl. H01M 4/36; H01M 4/505; H01M 4/525; C01G 53/00

(52) U.S. Cl. CPC H01M 4/366; H01M 4/505; H01M 4/525; C01G 53/42; C01G 53/50; C01P 2006/40; C01P 2004/86

(57) ABSTRACT

A main object of the present disclosure is to provide a coated active material capable of reducing a battery resistance. The present disclosure achieves the object by providing a coated active material comprising: an active material including Ni, and a coating layer configured to coat at least a part of a surface of the active material, and a NiO layer is formed between the active material and the coating layer, and an average thickness of the NiO layer is 0.9 nm or less.

### TECHNICAL FIELD

The present disclosure relates to a coated active material.

### BACKGROUND ART

A technique wherein a coating layer of, for example, an oxide is formed on the surface of an active material used for a battery has been known. For example, Patent Literature 1 discloses a method for producing an active material complex (coated active material) using a tumbling fluidized bed granulating-coating machine, by drying while spraying a specific coating liquid on the surface of an active material, and then, firing.

### CITATION LIST

### Patent Literature

Patent Literature 1: Japanese Patent No. 6269645

Summary of Disclosure

### Technical Problem

In the method for producing using the tumbling fluidized bed granulating-coating machine disclosed in Patent Literature 1, since a process in hot and humid conditions for a long period of time is necessary, the thickness of a NiO layer is increased due to Ni being oxidized on the surface of an active material including Ni, causing a problem of an increase of battery resistance.

The present disclosure has been made in view of the above circumstances, and a main object thereof is to provide a coated active material capable of reducing a battery resistance.

### Solution to Problem

The present disclosure provides a coated active material comprising: an active material including Ni, and a coating layer configured to coat at least a part of a surface of the active material, and a NiO layer is formed between the active material and the coating layer, and an average thickness of the NiO layer is 0.9 nm or less.

According to the present disclosure, by the average thickness of the NiO layer being a predetermined value or less, a coated active material capable of reducing a battery resistance, may be obtained.

In the disclosure, a maximum thickness of the NiO layer may be 0.9 nm or less.

The present disclosure provides a coated active material comprising: an active material including Ni, and a coating layer configured to coat at least a part of a surface of the active material, and a NiO layer is formed between the active material and the coating layer, and a maximum thickness of the NiO layer is 0.9 nm or less.

According to the present disclosure, by the maximum thickness of the NiO layer being a predetermined value or less, a coated active material capable of reducing a battery resistance, may be obtained.

In the disclosure, the active material is preferably a lithium transition metal composite oxide including Ni.

In the disclosure, a content of Ni in the active material is preferably 50 mol % or more with respect to a total of metal elements, excluding Li, included in the active material.

In the disclosure, the active material is preferably Li(Ni_{α}Co_{β}Mn_{γ})O₂ or Li(Ni_{α}Co_{β}Al_{γ})O₂, wherein α, β, and γ satisfy 0.5≤α, 0<β, 0<γ, 0<β+γ≤0.5 and α+β+γ=1.

In the disclosure, the coating layer preferably includes Nb.

### Advantageous Effects of Disclosure

The coated active material in the present disclosure exhibits an effect that it is capable of reducing a battery resistance.

### BRIEF DESCRIPTION OF DRAWINGS

FIG. 1 is a schematic cross-sectional view illustrating an example of a coated active material in the present disclosure.

FIG. 2 is a process flow diagram of a method for producing a coated active material in the present disclosure.

FIGS. 3A to 3C are views illustratively showing embodiments of a slurry liquid droplet.

FIGS. 4A and 4B are the results of the internal resistance in Example 1 and Comparative Example.

### DESCRIPTION OF EMBODIMENTS

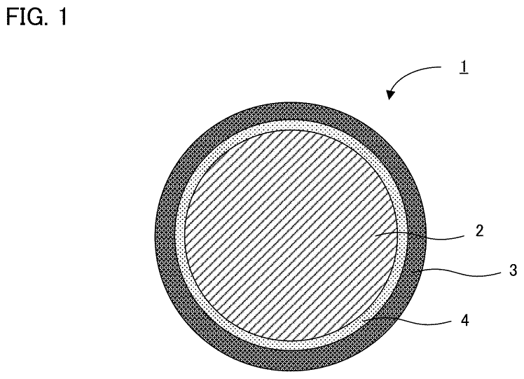

A coated active material in the present disclosure will be hereinafter described in detail. FIG. 1 is a schematic cross-sectional view illustrating an example of a coated active material in the present disclosure. Coated active material 1 shown in FIG. 1 comprises active material 2 including Ni, and coating layer 3 configured to coat at least a part of the surface of the active material 2, and NiO layer 4 is formed between the active material 2 and the coating layer 3. The average thickness of the NiO layer 4 is preferably 0.9 nm or less. Also, the maximum thickness of the NiO layer 4 is preferably 0.9 nm or less.

According to the present disclosure, by the average thickness or the maximum thickness of the NiO layer formed between the active material and the coating layer being a predetermined value or less, the battery resistance may be reduced.

1. NiO Layer

The average thickness of the NiO layer in the present disclosure is, for example, 0.9 nm or less, may be 0.8 nm or less, may be 0.7 nm or less, and may be 0.65 nm or less. Meanwhile, the average thickness of the NiO layer is, for example, 0.1 nm or more, may be 0.2 nm or more, and may be 0.3 nm or more. The average thickness of the NiO layer is, for example, the average value of the thickness obtained when a cross-section of the coated active material is observed by HAADF-STEM (high-angle annular dark field scanning transmission electron microscope), and a plurality of measurement sites are measured. The number of the measurement sites is, for example, 5 locations or more, may be 10 locations or more, and may be 100 locations or more.

Also, the maximum thickness of the NiO layer in the present disclosure is, for example, 0.9 nm or less, and may be 0.8 nm or less. Meanwhile, the maximum thickness of the NiO layer is, for example, 0.1 nm or more, may be 0.2 nm or more, and may be 0.3 nm or more. The maximum thickness of the NiO layer is, for example, the maximum value of the thickness obtained when a cross-section of the coated active material is observed by a HAADF-STEM (high-angle annular dark field scanning transmission electron microscope), and a plurality of measurement sites are measured. The number of measurement sites is, for example, 5 locations or more, and may be 10 locations or more.

When the NiO layer is too thick, a resistance increase may not be suppressed. Also, the amount of lithium ions those may be migrated is decreased, resulting in a decrease in capacity.

The NiO layer is a layer formed between the active material including Ni and the coating layer, and includes NiO. The fact that the NiO layer is formed between the active material including Ni and the coating layer may be confirmed by, for example, a HAADF-STEM analysis (high-angle annular dark field scanning transmission electron microscope analysis) of the cross-section of the coated active material.

The NiO layer may be formed on a part of the surface of the active material, and may be formed on the entire surface. The coverage of the active material by the NiO layer is, for example, 70% or more, may be 80% or more, and may be 90% or more. Meanwhile, the coverage may be 100%, and may be less than 100%. The coverage may be confirmed by, for example, a HAADF-STEM analysis (high-angle annular dark field scanning transmission electron microscope analysis).

2. Active Material

The active material may be a cathode active material, and may be an anode active material. The active material in the present disclosure includes Ni, and usually further includes Li. Also, the active material preferably includes 0. The active material is preferably a lithium transition metal composite oxide including at least Li, Ni and O. The active material may include one or two or more metal elements M, in addition to Li and Ni. An example of the metal element M is a transition metal. Also, other examples of the metal element M may include metals belonging to Groups 12 to 16 of the Periodic Table (including metalloids). Examples of the metal element M may include Co, Mn, Fe, V, and Al. The active material is preferably a lithium transition metal composite oxide including Li, Ni, Co, Mn and O; or a lithium transition metal composite oxide including Li, Ni, Co, Al, and O.

The crystal structure of the active material is not particularly limited, and examples thereof may include a rock salt bed type structure, a spinel structure, and an olivine structure.

The content of Ni in the active material is, for example, 30 mol % or more with respect to a total of metal elements, excluding Li, included in the active material. For example, when the active material is LiNi_{1/3}Co_{1/3}Mn_{1/3}O₂, the content of Ni in the active material is 33 mol %. Among them, in the present disclosure, a high-nickel active material whose Ni content is high is preferable. As compared with active materials other than the high-nickel active material, the NiO layer is easily formed on the high-nickel active material, and the battery resistance tends to be increased. Therefore, the effect due to the average thickness or the maximum thickness of the NiO layer being a predetermined value or less, may be remarkably obtained. The term “high-nickel active material” means an active material including 50 mol % or more of Ni. The content of Ni in the high-nickel active material may be 60 mol % or more, may be 70 mol % or more, may be 80 mol % or more, may be 90 mol % or more, and may be 100 mol %.

Examples of the high-nickel active material may include Li(Ni_{α}Co_{β}Mn_{γ})O₂ (α, β, and γ satisfy 0.5≤α, 0<β, 0<γ, 0<β+γ≤0.5 and α+β+γ=1); and Li(Ni_{α}Co_{β}Al_{γ})O₂ (α, β, and γ satisfy 0.5α, 0<β, 0<γ, 0<β+γ≤0.5 and α+β+γ=1). In these general formulas, a may be 0.6 or more, may be 0.7 or more, may be 0.8 or more, and may be 0.9 or more. Among them, for example, LiNi_{0.8}Mn_{0.15}Co_{0.05}O₂; LiNi_{0.8}Co_{0.1}Mn_{0.1}O₂; LiNi_{0.6}Co_{0.2}Mn_{0.2}O₂; LiNi_{0.8}Co_{0.1}Al_{0.1}O₂; and LiNi_{0.8}Co_{0.15}Al_{0.05}O₂ are preferable.

Among the active materials described above, a material whose charge-discharge potential is relatively noble may be used as a cathode active material, and a material whose charge-discharge potential is relatively less noble may be used as an anode active material. Only one type of the active material described above may be used alone, and two types or more of the active materials may be used in combination. The active material may be used for a sulfide all solid state battery.

The shape of the active material is not particularly limited as long as it is capable of forming a slurry liquid droplet. For example, the active material may be in a particulate form. The active material particle may be a solid particle, and may be a hollow particle. The active material particle may be a primary particle, and may be a secondary particle in which a plurality of primary particles are agglutinated. The average particle size (D50) of the active material particles may be, for example, 1 nm or more, may be 5 nm or more, and may be 10 nm or more; and the average particle size (D50) may be 500 μm or less, may be 100 μm or less, may be 50 μm or less, and may be 30 μm or less. Incidentally, the average particle size D50 is a particle diameter (median diameter) at an integrated value of 50% in the volume based particle size distribution determined by a laser diffractometry and scattering method.

3. Coating Layer

The coating layer covers at least a part of the surface of the active material via the NiO layer. The coating layer may have, for example, a function of suppressing an increase of an interface resistance between the active material and another material. The type of the coating liquid may be selected in accordance with the type of the active material to be coated, and the desired function.

The coating layer is preferably a layer including a lithium oxide including Li and an element A other than Li. Specific examples of the element A may include at least one type selected from the group consisting of B, C, Al, Si, P, S, Ti, Zr, Nb, Mo, Ta, and W. Among them, Nb is preferable.

The coating layer is, for example, a layer including a lithium oxide including Li and Nb. Examples of the lithium oxide including Li and Nb may include lithium niobate (such as LiNbO₃); and lithium niobium titanium based oxide (such as LiNbTiO₃). The coating layer may include only one type of lithium oxide, and may include two types or more thereof.

The coating layer preferably includes the lithium oxide as a main component. The ratio of the lithium oxide in the coating layer is, for example, 70 wt % or more, may be 80 wt % or more, and may be 90 wt % or more.

The thickness of the coating layer is not particularly limited, and may be, for example, 0.1 nm or more, may be 0.5 nm or more, and may be 1 nm or more. Meanwhile, the thickness may be 500 nm or less, may be 300 nm or less, may be 100 nm or less, may be 50 nm or less, and may be 20 nm or less. The coating layer covers at least a part of the surface of the active material via the NiO layer. The coating layer may be formed on a part of the surface of the active material, and may be formed on the entire surface of the active material. The coverage of the active material by the coating layer is, for example, 70% or more, may be 80% or more, and may be 90% or more. Meanwhile, the coverage may be 100%, and may be less than 100%. Incidentally, the coverage of the coating layer on the surface of the active material may be calculated by observing, for example, a scanning electron microscope (SEM) image, or a high-angle annular dark field scanning transmission electron microscope (HAADF-STEM) image of the cross-section of the particles, and may be calculated by calculating the element ratio of the surface by X-ray photoelectron spectroscopy (XPS).

The coating layer may include a plurality of holes. The holes may be, for example, cavities, bubbles (voids), or clearances (gaps). The shape of each hole is not particularly limited. For example, the cross-sectional shape of each hole may be a circular shape, and may be an elliptical shape. The size of each hole is not particularly limited. For example, when the cross-section of the coated active material is observed, the equivalent circle diameter of the holes may be 10 nm or more and may be 300 nm or less. The number of the holes in the coating layer is not particularly limited. The position of the hole in the coating layer is not particularly limited; a hole may be present at the interface between the active material and coating layer, and a hole may be present in the coating layer. The coating layer may have a plurality of holes enclosed inside (on the active material side) than its outermost surface (on the surface opposite to the active material).

By the coating layer including a plurality of holes, the following effects may be expected. For example, the contacting between the coated active material and other battery materials may be improved so that the transfer of electrons or ions may be facilitated. Also, the coated active material exhibits cushioning property, which may improve performance when the coated active material is used for an electrode or a battery. For example, even when the active material is expanded during charging and discharging, or when a pressure is applied to the coated active material during a press treatment of the electrode, for example, it is considered that the stress applied to the active material is reduced by the cushioning property, and cracking of the active material is suppressed.

4. Coated Active Material

The particle size (D90) of the coated active material is not particularly limited, and may be, for example, 1 nm or more, may be 10 nm or more, may be 100 nm or more, may be 1 μm or more, may be 2 μm or more, may be 3 μm or more, may be 4 μm or more, may be 5 μm or more, may be 6 μm or more, may be 7 μm or more, may be 8 μm or more, and may be 9 μm or more. Meanwhile, the size may be 50 μm or less, may be 30 μm or less, may be 20 μm or less, and may be 10 μm or less. Incidentally, the particle size D90 is a particle size at an integrated value of 90% in the volume based particle size distribution determined by a laser diffractometry and scattering method.

5. Method for Producing Coated Active Material

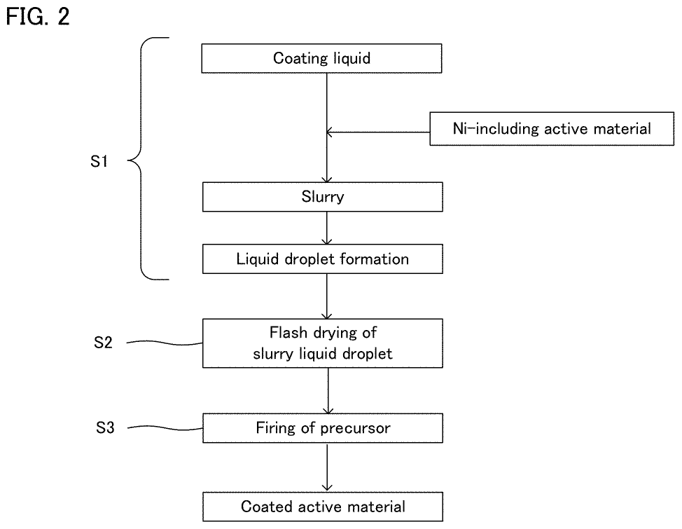

The method for producing a coated active material in the present disclosure is not particularly limited. Meanwhile, the present disclosure is able to provide a method for producing the coated active material described above, the method comprising: a first step of obtaining a slurry liquid droplet by forming a slurry including the active material including Ni and a coating liquid into a liquid droplet; a second step of obtaining a precursor by flash drying the slurry liquid droplet in a heated gas; and a third step of firing the precursor. For example, as shown in FIG. 2, the present disclosure is able to provide a method for producing a coated active material, the method comprising: a first step S1 of obtaining a slurry liquid droplet by forming a slurry including an active material including Ni and a coating liquid into a liquid droplet; a second step S2 of obtaining a precursor by flash drying the slurry liquid droplet in a heated gas; and a third step S3 of firing the precursor.

In the Patent Literature 1 described above, in order to ensure powder fluidity, the coating liquid is sprayed onto the active material little by little and dried repeatedly, and processing for a long time (for example, 2 hours or more) in hot and humid conditions is required, so that it is not possible to suppress thickening of the NiO layer.

Meanwhile, according to the method described above, the liquid droplet forming treatment of the slurry and the flash drying treatment may be carried out in a short time (for example, 5 seconds or less, preferably 1 second or less). Therefore, coating layer may be formed while suppressing thickening of the NiO layer. Specifically, the enlargement ratio (%) of the NiO layer before and after formation of the coating layer may be reduced. The enlargement ratio (%) of the NiO layer is calculated by (thickness of NiO layer of coated active material−thickness of NiO layer of raw material active material)/(thickness of NiO layer of raw material active material)×100.

The enlargement ratio of the average thickness of the NiO layer is, for example, less than 125%, may be 100% or less, may be 50% or less, and may be 10% or less. The average thickness of the NiO layer of the raw material active material is, for example, 1.2 nm or less, may be 1.0 nm or less, and may be 0.8 nm or less. Meanwhile, the average thickness of the NiO layer of the coated active material is, for example, 0.9 nm or less, and may be 0.8 nm or less.

The enlargement ratio of the maximum thickness of the NiO layer is, for example, less than 114%, may be 100% or less, may be 50% or less, and may be 10% or less. The maximum thickness of the NiO layer of the raw material active material is, for example, 1.2 nm or less, may be 1.0 nm or less, and may be 0.8 nm or less. Meanwhile, the maximum thickness of the NiO layer of the coated active material is, for example, 1.3 nm or less, may be 1.2 nm or less, may be 1.0 nm or less, and may be 0.8 nm or less.

The enlargement ratio of the minimum thickness of the NiO layer is, for example, less than 150%, may be 100% or less, may be 50% or less, and may be 10% or less. The minimum thickness of the NiO layer of the raw material active material is, for example, 0.6 nm or less, may be 0.5 nm or less, and may be 0.4 nm or less. Meanwhile, the minimum thickness of the NiO layer of the coated active material is, for example, 0.7 nm or less, may be 0.6 nm or less, may be 0.5 nm or less, and may be 0.4 nm or less.

(1) First Step

The present step is a step of obtaining a slurry liquid droplet by forming a slurry including an active material including Ni and a coating liquid into a liquid droplet.

(a) Active Material

The active material may be similar to the content of “2. Active Material”, and therefore, the description herein will be omitted.

(b) Coating Liquid

The coating liquid constitutes the coating layer that exhibits a predetermined function on the surface of the active material, after flash drying and firing which will be described later. The type of the coating liquid may be selected according to the type of the active material to be coated and the desired function. When a layer including an oxide including Li and the element A other than Li, is provided on the surface of the active material, the coating liquid may include a lithium source and an A source. Since the element A is similar to the content described in “3. Coating layer”, the description herein is omitted. For example, when a lithium niobate layer is provided on the surface of the active material, the coating liquid may include a lithium source and a niobium source.

The coating liquid may include lithium ions as a lithium source. For example, a coating liquid including lithium ions as a lithium source may be obtained by dissolving a lithium compound such as LiOH, LiNO₃, Li₂SO₄ in a solvent. Alternatively, the coating liquid may include an alkoxide of lithium as the lithium source.

Also, the coating liquid may include a peroxo complex of niobium as a niobium source. The coating liquid may include an alkoxide of niobium as the niobium source.

The molar ratio of the lithium source to the niobium source included in the coating liquid is not particularly limited, and may be, for example, Li:Nb=1:1. Hereinafter, (i) a coating liquid including lithium ions and a peroxo complex of niobium; and (ii) a coating liquid including an alkoxide of lithium and an alkoxide of niobium are exemplified.

(i) Coating Liquid Including Lithium Ions and Peroxo Complex of Niobium

The coating liquid may be obtained, for example, by preparing a transparent solution by using, for example, hydrogen peroxide solution, niobium acid, and ammonia water, and then, adding a lithium compound to the transparent solution. Incidentally, the structural formula of the peroxo complex of niobium ([Nb(O₂)₄]³⁻)) is, for example, as follows.

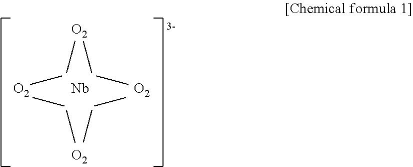

(ii) Coating Liquid Including Alkoxide of Lithium and Alkoxide of Niobium

The coating liquid may be obtained, for example, by dissolving an ethoxylithium powder in a solvent, and then, adding a predetermined amount of pentaethoxyniobium thereto. In this case, examples of the solvent may include dehydrated ethanol, dehydrated propanol, and dehydrated butanol.

(c) Slurry

The “slurry” may be a suspension body or a suspension liquid including an active material and a coating liquid, having fluidity to the extent to allow the formation of liquid droplets. In the method in the present disclosure, the slurry may have fluidity to the extent to allow the formation of liquid droplets by using, for example, a spray nozzle or a rotary atomizer. Incidentally, the slurry may include any solid component or liquid component in addition to the active material and the coating liquid described above.

The solid content concentration, for example, capable of forming liquid droplets may vary depending on, for example, the type of the active material, the type of the coating liquid, and conditions of liquid droplet formation (the type of device used for the liquid droplet formation). The solid content concentration in the slurry is not particularly limited, and may be, for example, 1 wt % or more, may be 10 wt % or more, may be 20 wt % or more, may be 30 wt % or more, may be 40 wt % or more, and may be 50 wt % or more; and the solid content concentration may be 70 wt % or less, may be 60 wt % or less, may be 50 wt % or less, and may be 40 wt % or less.

(d) Slurry Liquid Droplet Formation

The slurry “liquid droplet formation” means that the slurry including the active material and the coating liquid is formed into a grain including the active material and the coating liquid.

In the first step, examples of the method for forming the slurry including the active material and the coating liquid into a liquid droplet may include a method wherein the slurry including the active material and the coating liquid is formed into a liquid droplet by spraying using a spray nozzle. Although not limited thereto, examples of the method for spraying the slurry using a spray nozzle may include a pressurizing nozzle method, a two-fluid nozzle method, and a four-fluid nozzle method. In the present disclosure, a four-fluid nozzle method is preferable.

When the slurry is sprayed using a spray nozzle, the nozzle diameter is not particularly limited. The nozzle diameter may be, for example, 0.1 mm or more, and may be 1 mm or more. Meanwhile, it may be 10 mm or less, and may be 1 mm or less. Also, the spraying speed of the slurry (the feed speed of the slurry with respect to the spray nozzle) is also not particularly limited. The spraying speed may be, for example, 0.1 g/second or more, and may be 1 g/second or more. Meanwhile, it may be 5 g/second or less, and may be 0.5 g/second or less. The spraying speed may be adjusted according to, for example, the viscosity or the solid content concentration of the slurry, or the nozzle size.

In addition to the method wherein the slurry is sprayed using a spray nozzle as described above, examples of the method for forming the slurry into a liquid droplet may include a method wherein the slurry is formed into a liquid droplet by centrifugal force by feeding the slurry including the active material and the coating liquid onto a rotating circular disk at a constant speed. Also in this case, the feeding speed of the slurry may be, for example, 0.1 g/second or more, and may be 1 g/second or more; and it may be 5 g/second or less, and may be 0.5 g/second or less, and the feeding speed may be adjusted according to, for example, the viscosity or the solid content concentration of the slurry, or the nozzle size. Alternatively, a method wherein the slurry is formed into a liquid droplet by applying high voltage to the surface of the slurry including the active material and the coating liquid, may also be employed.

In the method in the present disclosure, the liquid droplet formation of the slurry (first step) and flash drying (second step) may be carried out using, for example, a spray dryer. The method of the spray dryer is not particularly limited, and examples thereof may include a method using the spray nozzle described above, and a method using a rotating circular disk.

(e) Slurry Liquid Droplet

The “slurry liquid droplet” is a grain of the slurry including the active material and the coating liquid. The size of the slurry liquid droplet is not particularly limited. The diameter (spherical equivalent diameter) of the slurry liquid droplet may be, for example, 0.5 μm or more, and may be 5 μm or more. Meanwhile, the diameter may be 5000 μm or less, and may be 1000 μm or less. The diameter of the slurry liquid droplet may be measured using, for example, a two-dimensional image obtained by imaging the slurry liquid droplet, or may be measured using a particle size distribution meter of a laser diffraction type. Alternatively, the liquid droplet diameter may be estimated from, for example, the operating conditions of the device for forming the slurry liquid droplet.

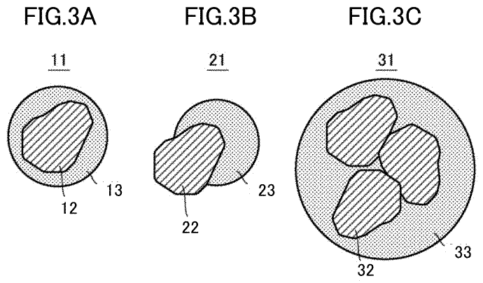

In the method in the present disclosure, a drop of the slurry liquid droplet may include, for example, one active material particle and coating liquid adhered thereto, and may include a plurality of active material particles (particle group) and coating liquid adhered thereto. FIG. 3 are views illustratively showing embodiments of a slurry liquid droplet. Incidentally, in FIG. 3, the NiO layer is omitted for convenience.

As shown in FIG. 3A, a slurry liquid droplet 11 may include one active material particle 12 and a coating liquid 13 adhered thereto, and the coating liquid 13 may cover the entire surface of the active material particle 12.

As shown in FIG. 3B, the slurry liquid droplet 21 may include one active material particle 22 and a coating liquid 23 adhered thereto, and the coating liquid 23 may cover a part of the surface of the active material particle 22.

As shown in FIG. 3C, the slurry liquid droplet 31 may include a plurality of active material particles 32 and a coating liquid 33 adhered thereto. The coating liquid 33 may cover the entirety of the plurality of the active material particles 32, and may cover a part thereof.

(2) Second Step

In the second step, a precursor is obtained by flash drying the slurry liquid droplet obtained in the first step in a heated gas. The “precursor” refers to a precursor of the intended coated active material, and refers to a condition prior to the firing treatment in the third step described below. In the second step, a precursor wherein a layer including a component derived from the coating liquid is formed on the surface of the active material, may be obtained by flash drying the slurry liquid droplet.

Incidentally, in the method in the present disclosure, “flash drying” means drying the slurry liquid droplet while being suspended in a high-temperature gas flow. The “flash drying” may include not only drying but also an operation associated with the use of a dynamic gas flow. A force is continuously applied to the slurry liquid droplet or the precursor, by continuously applying hot air to the slurry liquid droplet or the precursor by flash drying. Using this, for example, the second step may include disintegrating (crushing) the slurry liquid droplet or the precursor by flash drying.

Specifically, when the slurry liquid droplet is flash dried, one slurry liquid droplet may be crushed into each active material particle or active material particle group to obtain a plurality of slurry liquid droplets, or one agglutinated precursor may be crushed into each active material particle or active material particle group to obtain a plurality of precursors. In other words, in the method in the present disclosure, even when the granules of the slurry liquid droplets or the precursor are formed, the granules may be crushed by flash drying. Therefore, it is also possible to use a slurry having low solid content concentration, and it is easy to increase the treatment speed. Thus, in the second step, by crushing the slurry liquid droplet or the precursor by flash drying, it is easy to shorten the production time, as well as it is easy to produce high performance coated active material.

In the second step, the drying and the crushing may be carried out simultaneously, and may be carried out separately. In the second step, a first flash drying wherein the drying of the slurry liquid droplet is dominant, and a second flash drying wherein the crushing of the precursor is dominant, may be carried out. Also, the second step may be carried out repeatedly.

In the second step, the temperature of the heated gas may be any temperature capable of volatilizing the solvent from the slurry liquid droplet. For example, the temperature may be 100° C. or more, may be 130° C. or more, may be 160° C. or more, may be 190° C. or more, may be 200° C. or more, may be 210° C. or more, may be 220° C. or more, may be 230° C. or more, may be 240° C. or more, and may be 250° C. or more. It is preferable that the temperature of the heated gas is higher since the flash drying in the second step may be carried out in a short time, and the thickening of the NiO layer may be suppressed.

In the second step, the supplied gas amount (flow amount) of the heated gas may be appropriately set in consideration of, for example, the size of the device to be used, the supplied amount of the slurry liquid droplet. For example, the flow amount of the heated gas may be, for example, 0.10 m³/min or more, may be 0.20 m³/min or more, may be 0.30 m³/min or more, may be 0.40 m³/min or more, may be 0.60 m³/min or more, may be 0.80 m³/min or more, may be 1.00 m³/min or more, may be 1.10 m³/min or more, and may be 1.20 m³/min or more. Meanwhile it may be 5.00 m³/min or less, may be 4.00 m³/min or less, may be 3.00 m³/min or less, and may be 2.00 m³/min or less. It is preferable that the supplied gas amount (flow amount) of the heated gas is high since the flash drying in the second step may be carried out in a short time, and the thickening of the NiO layer may be suppressed.

In the second step, the supplied gas speed (flow speed) of the heated gas may also be appropriately set in consideration of, for example, the size of the device to be used, and the supply amount of the slurry liquid droplet. For example, the flow speed of the heated gas may be 1 m/second or more, and may be 5 m/second or more, in at least a portion of the system. Meanwhile, it may be 50 m/second or less, and may be 10 m/second or less.

In the second step, the treatment time (drying time) by the heated gas may also be appropriately set in consideration of, for example, the size of the device to be used, and the supply amount of the slurry liquid droplet.

Also, when carrying out the slurry liquid droplet formation (first step) and the flash drying (second step) using a spray dryer, the sum of the treatment time of the slurry liquid droplet formation (spraying time) and the treatment time of the flash drying by the heated gas is, for example, 5 seconds or less, and may be 1 second or less. It is preferable to carry out the slurry liquid droplet formation treatment and the flash drying treatment by the heated gas in a short time, since the thickening of the NiO layer may be suppressed.

In the second step, a heated gas that is substantially inert to the active material and the coating liquid may be used. For example, an oxygen-containing gas such as air; an inert gas such as nitrogen and argon; and a dry air having low dew point may be used. In this case, the dew point may be −10° C. or less, may be −50° C. or less, and may be −70° C. or less.

As a device for carrying out the flash drying, for example, a spray dryer may be used, but is not limited thereto.

(3) Third Step

In the third step, the precursor obtained in the second step is fired. Accordingly, a coated active material having the coating layer on at least a part of the surface of the active material including Ni, may be obtained.

As a firing device, for example, a muffle furnace, and a hot plate may be used, although not limited thereto.

The firing conditions are not particularly limited, and may be appropriately set in accordance with the type of the coated active material. Hereinafter, the firing conditions, when a coated active material including a coating layer including lithium niobate on the surface of a cathode active material is produced, are exemplified.

For example, the precursor is obtained by carrying out the first step and the second step described above using an oxide particle including Li and Ni as the cathode active material, and using a solution including a lithium ion and a peroxo complex of niobium as the coating liquid. By firing the obtained precursor, a coating layer including lithium niobate may be formed on the surface of an oxide including lithium and nickel which is a cathode active material.

In this case, the firing temperature may be, for example, 100° C. or more, may be 150° C. or more, may be 180° C. or more, may be 200° C. or more, and may be 230° C. or more. Meanwhile, the temperature may be 350° C. or less, may be 300° C. or less, and may be 250° C. or less. The firing temperature in the third step may be higher than the temperature of the flash drying in the second step. The firing time may be, for example, 1 hour or more, may be 2 hours or more, may be 3 hours or more, may be 4 hours or more, may be 5 hours or more, and may be 6 hours or more. Meanwhile, it may be 20 hours or less, may be 15 hours or less, and may be 10 hours or less. The atmosphere for firing may be, for example, an air atmosphere, a vacuum atmosphere, a dry air atmosphere, a nitrogen gas atmosphere, or an argon gas atmosphere.

6. Electrode Layer

The coated active material in the present disclosure may be used, for example, as an active material for an electrode layer of an all solid state battery. That is, the present disclosure may provide an electrode layer used for an all solid state battery, wherein the electrode layer includes the coated active material described above. As used herein, “all solid state battery” refers to a battery including a solid electrolyte layer (a layer including at least solid electrolyte). The electrode layer may be a cathode layer, and may be an anode layer. The electrode layer includes the coated active material described above, and may include a solid electrolyte, a conductive material, and a binder.

As the solid electrolyte, one known as a solid electrolyte for an all solid state battery may be used. For example, an oxide solid electrolyte which is a Li including oxide of a perovskite type, a nasicon type, or a garnet type; or a sulfide solid electrolyte including Li and S as constituent elements may be used. In particular, when the sulfide solid electrolyte is used, higher effects due to the technique in the present disclosure may be expected. Specific examples of the sulfide solid electrolyte may include, and are not limited to, LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—P₂S₅, and Li₃PS₄. The solid electrolyte may be amorphous, and may be crystalline. Only one type of the solid electrolyte may be used alone, and two types or more solid electrolytes may be used in a combination.

Specific examples of the conductive material may include, and are not limited to, carbon materials such as vapor-grown carbon fiber (VGCF), acetylene black (AB), Ketjen black (KB), carbon nanotube (CNT), and carbon nanofiber (CNF); or metal materials capable of withstanding the conditions of the environment wherein an all solid state lithium ion battery is used. Only one type of the conductive material may be used alone, and two types or more conductive materials may be used in a combination.

Specific examples of the binder may include, and are not limited to, acrylonitrile butadiene rubber (ABR) based binders, butadiene rubber (BR) based binders, polyvinylidene fluoride (PVdF) based binders, styrene butadiene rubber (SBR) based binders, and polytetrafluoroethylene (PTFE) based binders. Only one type of the binder may be used alone, and two types or more binders may be used in a combination.

The method for producing an electrode in the present disclosure may include obtaining a coated active material by the method for producing a coated active material described above; mixing the coated active material with a solid electrolyte to obtain an electrode mixture (mixing step); and shaping the electrode mixture to obtain an electrode (shaping step).

In the mixing step, the coated active material and solid electrolyte are mixed to obtain an electrode mixture. In the mixing step, in addition to the coated active material and solid electrolyte, a conductive material and a binder may further be mixed optionally. The content of the coated active material in the electrode mixture is not particularly limited, and may be, for example, 40 wt % or more and 99 wt % or less. The coated active material and solid electrolyte may be mixed by a dry method, and may be mixed by a wet method using an organic solvent (preferably a non-polar solvent).

The electrode mixture may be shaped by a dry method, and may be shaped by a wet method. Also, the electrode mixture may be shaped alone, and may be shaped together with a current collector. Further, the electrode mixture may be integrally shaped on the surface of the solid electrolyte layer described later. Examples of the shaping step may include an embodiment wherein an electrode is produced via processes of applying a slurry including an electrode mixture to the surface of a current collector, and then, drying and optionally pressing thereof; and an embodiment wherein an electrode mixture in a powder form is put into a mold, for example, and press-molded by a dry method to produce an electrode.

7. All Solid State Battery

The present disclosure is able to provide an all solid state battery comprising: a cathode layer; an anode layer; and a solid electrolyte layer placed between the cathode layer and the anode layer, wherein at least one of the cathode layer and the anode layer includes the coated active material described above. The all solid state battery usually includes a cathode current collector configured to collect current of the cathode layer, and an anode current collector configured to collect currents of the anode layer. The cathode current collector is placed, for example, on the surface of the cathode layer which is opposite to the solid electrolyte layer. Examples of the material of the cathode current collector may include metals such as aluminum, SUS, and nickel. Examples of the shape of the cathode current collector may include a foil shape and a mesh shape. Meanwhile, the anode current collector is placed, for example, on the surface of the anode layer which is opposite to the solid electrolyte layer. Examples of the material of the anode current collector may include metals such as copper, SUS, and nickel. Examples of the shape of the anode current collector may include a foil shape and a mesh shape.

The solid electrolyte layer may be, for example, a layer including a solid electrolyte and a binder. The types of the solid electrolyte and the binder are as described above. An all solid state battery may be produced via obvious processes such as stacking of the electrode and solid electrolyte layer; connecting of a terminal to the electrode; storing into a battery case; and confining the battery.

The all solid state battery may include an exterior body that houses a power generation element. Examples of the exterior body may include a laminate type exterior body and a case type exterior body. Also, the all solid state battery in the present disclosure may include a confining jig that applies a confining pressure to the power generation element in the thickness direction. As the confining jig, a known jig may be used. The confining pressure may be, for example, 0.1 MPa or more and 50 MPa or less, and may be 1 MPa or more and 20 MPa or less. When the constraining pressure is low, a good ion conducting path and a good electron conducting path may not be formed. Meanwhile, when the confining pressure is high, the confining jig is enlarged, so that the volume energy density may be decreased.

The type of the all solid state battery is not particularly limited, and is typically a lithium ion secondary battery. The application of the all solid state battery is not particularly limited; and examples thereof may include a power supply of a vehicle such as a hybrid electric vehicle (HEV), a plug-in hybrid electric vehicle (PHEV), a battery electric vehicle (BEV), a gasoline-powered vehicle, and a diesel-powered vehicle. In particular, it is preferably used in the driving power supply of a hybrid electric vehicle, a plug-in hybrid electric vehicle, or a battery electric vehicle. Also, the all solid state battery in the present disclosure may be used as a power source for moving objects other than vehicles (such as railroad vehicles, ships, and airplanes), and may be used as a power source for electric appliances such as information processing apparatuses.

The present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

### Example 1

(Preparation of Coating Liquid)

Into a container including 870.4 g of hydrogen peroxide solution with concentration of 30 wt %, 987.4 g of ion-exchanged water and 44.2 g of niobium acid (Nb₂O₅·3H₂O (Nb₂O₅, water content of 72%)) were added. Then, to the container, 87.9 g of ammonia water with concentration of 28 wt % was added. Then, after adding the ammonia water, a transparent solution was obtained by thoroughly stirring the contents of the container. Further, by adding 10.1 g of lithium hydroxidemonohydrate (LiOHH₂O) to the obtained transparent solution, a complex solution including a peroxo complex of niobium and a lithium ion was obtained as a coating liquid.

(Preparation of Slurry)

As a raw material active material, LiNi_{0.8}Co_{0.1}Al_{0.1}O₂ (NCA) was charged into a mixing container, the coating liquid prepared above was added so that the solid content concentration of the slurry was 66 wt %, and stirred with a magnetic stirrer. Thereby, a slurry was obtained.

(Preparation of Coated Active Material Precursor)

Using a liquid feeding pump, the slurry prepared above was fed to a spraying dryer (micromist spray dryer MDL-050MC from GGF Corporation) at speed of 0.5 g/second, a formation of slurry liquid droplet and a flash drying of the slurry liquid droplet were carried out, and a precursor was obtained. Incidentally, the sum of the treatment time (spraying time) of the slurry liquid droplet formation and the treatment time of the flash drying was 1 second. The operating conditions of the spray dryer were as follows. Supplied gas temperature: 250° C.

Supplied gas amount: 1.1 m³/minute

(Firing of Precursor)

Using a muffle furnace, the precursor was fired at 230° C. for 6 hours, and lithium niobate was synthesized on the surface of the active material. Thereby, a coated active material was obtained.

### Example 2

The preparation of a coating liquid, the preparation of a slurry, the preparation of a coated active material precursor, and the firing of the precursor were carried out in the same manner as in Example 1 except that, LiNi_{1/3}Co_{1/3}Mn_{1/3}O₂ (NCM) was used as the raw material active material. Thereby, a coated active material was obtained.

### Comparative Example

A coated active material precursor was obtained by repeating a spraying and a drying of 650 g of the coating liquid prepared above, using a tumbling fluidized bed granulating-coating machine “MP-01” (from Powrex Corp.), onto 2 kg of LiNi_{0.8}Co_{0.1}Al_{0.1}O₂ (NCA) (from Sumitomo Metal Mining Co., Ltd.) as the active material, for 2.3 hours. A coated active material according to Comparative Example was obtained by firing the obtained precursor under the same conditions as Example described above.

Incidentally, the operating conditions of the tumbling fluidized bed granulating-coating machine were as follows.

Atmosphere gas: dry air having dew point of −65° C. or less
Supplied gas temperature: 200° C.
Supplied gas amount: 0.45 m³/min
Rotor rotation: 400 rpm
Spraying speed: rose in stages from 4.8 g/min to 9.6 g/min

[Production of Battery]

(Preparation of Cathode Paste)

A cathode paste was prepared by weighing and mixing the followings using an ultrasonic homogenizer; the coated active material in each of the Examples and Comparative Example, a sulfide solid electrolyte (10LiI-15LiBr-37.5Li₃PS₄), vapor-grown carbon fiber (VGCF) and acetylene black (AB) as conductive materials, styrene butadiene rubber (SBR) as a binder, and a tetralin solution.

(Production of Anode Paste)

A slurry was obtained by mixing a predetermined amount of Li₄Ti₅O₁₂ particles as anode active material, VGCF as a conductive material, a SBR binder, and diisobutyl ketone, and mixing thereof using an ultrasonic homogenizer. Then, a sulfide solid electrolyte was added to the slurry, mixed again using an ultrasonic homogenizer, and an anode paste was prepared.

(Paste for Solid Electrolyte Layer)

A heptane, a heptane solution containing 5 wt % of a butadiene rubber based binder, and LiI—LiBr—Li₂S—P₂S₅ based glass ceramic as a solid electrolyte were added to a polypropylene container, mixed for 30 seconds with an ultrasonic homogenizer. Then, the container was shaken with a shaker for 3 minutes, and a paste for a solid electrolyte layer was obtained.

(Production of Cathode, Anode, and Solid Electrolyte Layer)

Firstly, the cathode paste was applied onto a cathode current collector (an aluminum foil) by a blade method using an applicator. After the application, the cathode paste was dried for 30 minutes on a hot plate adjusted to be 100° C. Thereby, a cathode including a cathode current collector and a cathode layer was obtained. Then, the anode paste was applied onto an anode current collector (a copper foil), and dried. Thereby, an anode including an anode current collector and an anode layer was obtained. Here, applied weight of the anode layer was adjusted so that the charge specific capacity of the anode was 1.15 times when the charge specific capacity of the cathode was 200 mAh/g. Then, the paste for a solid electrolyte layer was applied onto an aluminum foil, dried for 30 minutes on a hot plate adjusted to be 100° C., and a stacked body including an aluminum foil and a solid electrolyte layer was obtained.

(Production of Cathode Side Stacked Body and Anode Side Stacked Body)

The obtained cathode and the stacked body were adhered so that the cathode active material layer and the solid electrolyte layer faced to each other, roll pressed under the conditions of 175° C. and 5 ton/cm, and a cathode side stacked body including the cathode current collector (aluminum foil), the cathode layer and the solid electrolyte layer was obtained by peeling off the aluminum foil on the solid electrolyte layer. Then, for the anode, an anode side stacked body including the anode current collector (copper foil), the anode layer and the solid electrolyte layer was obtained under the same conditions.

The cathode side stacked body and the anode side stacked body were punched out respectively, and they were stacked so that the solid electrolyte layers faced to each other. Here, the solid electrolyte layer of the cathode side stacked body and the solid electrolyte layer of the anode side staked body were stacked with un unpressed solid electrolyte layer (paste for a solid electrolyte layer) transferred therebetween. Then, a power generation element including a cathode, a solid electrolyte layer, and an anode in this order was obtained by pressing the staked body under 2 ton/cm² at 130° C. The obtained power generation element was laminate-enclosed, confined under 5 MPa, and an all solid state lithium ion secondary battery for evaluation was obtained.

[Measurement of NiO Layer Thickness]

The cross-section of the raw material active material used in Examples 1 and 2 and Comparative Example was previously observed by HAADF-STEM (high-angle annular dark field scanning transmission electron microscope), and the thickness of the NiO layer formed on the surface of the raw material active material was measured. The measurement was carried out at 6 places in Example 1 and Example 2, and 3 places in Comparative Example. Also, the average value, the minimum value, and the maximum value of the thickness of the NiO layer at these plurality of measurement sites were determined. The results are shown in Table 1.

The cross-section of the coated active material produced in the manner described above was observed by HAADF-STEM (high-angle annular dark field scanning transmission electron microscope), and the thickness of the NiO layer was measured. The measurement was carried out at 12 placed in Example 1, 6 places in Example 2, and 3 places in Comparative Example. Also, the average value, the minimum value, and the maximum value of the thickness of the NiO layer at these plurality of measurement sites were determined. The results are shown in Table 1.

The enlargement ratio of the average thickness of the NiO layer before and after formation of the coating layer was calculated by the following formula.

Enlargement ratio (average thickness)(%)=(average thickness of NiO layer of coated active material−average thickness of NiO layer of raw material active material)/(average thickness of NiO layer of raw material active material)×100.

Similarly, the enlargement ratio of the minimum thickness, and the enlargement ratio of the maximum thickness of the NiO layer were calculated. The results are shown in Table 1.

TABLE 1

| | | | | NiO layer thickness of | | | | NiO layer thickness of | | | | | | | |
|---|---|---|---|---|---|---|---|---|---|---|---|---|---|---|---|
| | | | | raw material active material | | | | coated active material | | | | | | | |
| | | Spray- | | Measurment | | | | Measurment | | | | | Enlargement ratio | | |
| | Active | ing•drying | | value | Min. | max. | Ave. | value | | Min. | Max. | Ave. | Min. | Max. | Ave. |
| | material | time | | [nm] | [nm] | [nm] | [nm] | [nm] | | [nm] | [nm] | [nm] | [%] | [%] | [%] |
| Comp. Ex. | NCA | 2.3 | hr | 0.7 | 0.6 | 0.7 | 0.67 | 1.5 | | 1.5 | 1.5 | 1.5 | 150 | 114 | 125 |
| | | | | 0.7 | | | | 1.5 | | | | | | | |
| | | | | 0.6 | | | | 1.5 | | | | | | | |
| Example 1 | NCA | 1 | sec | 0.4 | 0.4 | 1.2 | 0.8 | 0.4 | 0.6 | 0.4 | 0.9 | 0.63 | 0 | −25 | −21 |
| | | | | 0.6 | | | | 0.4 | 0.7 | | | | | | |
| | | | | 0.7 | | | | 0.4 | 0.9 | | | | | | |
| | | | | 1.0 | | | | 0.5 | 0.6 | | | | | | |
| | | | | 0.9 | | | | 0.9 | 0.8 | | | | | | |
| | | | | 1.2 | | | | 0.6 | 0.8 | | | | | | |
| Example 2 | NCM | 1 | sec | 0.9 | 0.3 | 0.9 | 0.52 | 0.3 | | 0.3 | 0.7 | 0.42 | 0 | −22 | −19 |
| | | | | 0.7 | | | | 0.3 | | | | | | | |
| | | | | 0.6 | | | | 0.3 | | | | | | | |
| | | | | 0.3 | | | | 0.7 | | | | | | | |
| | | | | 0.3 | | | | 0.4 | | | | | | | |
| | | | | 0.3 | | | | 0.5 | | | | | | | |

[Measurement of Resistance]

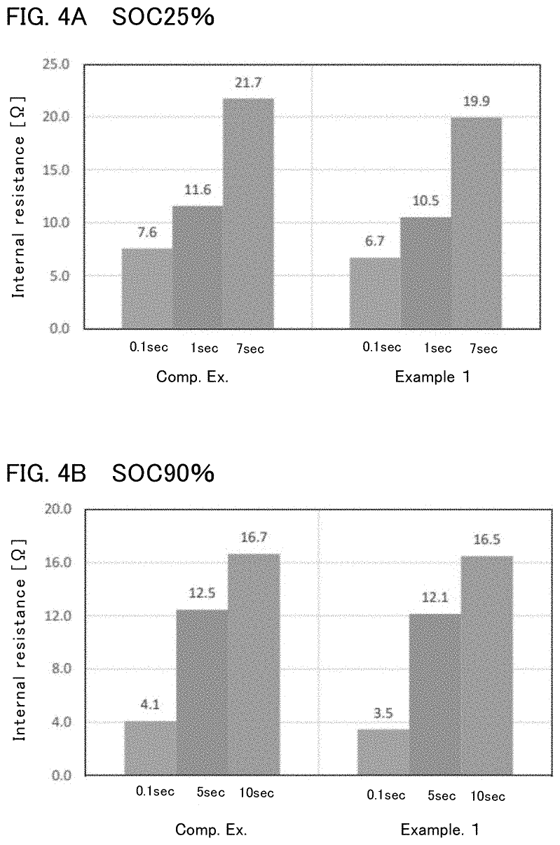

For each of the all solid state lithium ion battery in Example 1 and Comparative Example produced by the methods described above, a DCIR measurement was carried out, and the resistance was determined. In the measurement, a 6C discharge was carried out at 25° C. from SOC (state of charge) 25% for the period described in Table 2, and the internal resistance was determined from the voltage drop amount and the current value thereof. Also, a 6C discharge was carried out from SOC 90% for the period described in Table 2, and the internal resistance was determined from the voltage drop amount and the current value thereof. The results are shown in Table 2 and FIGS. 4A and 4B.

TABLE 2

| | Resistance value [Ω] | | | | | |
|---|---|---|---|---|---|---|
| | SOC25% | | | SOC90% | | |
| | 0.1 sec | 5 sec | 10 sec | 0.1 sec | 1 sec | 7 sec |
| Comp. Ex. | 7.6 | 11.6 | 21.7 | 4.1 | 12.5 | 16.7 |
| Example 1 | 6.7 | 10.5 | 19.9 | 3.5 | 12.1 | 16.5 |

From the results in Table 1, it was confirmed that the thickness of the NiO layer in Example 1 and Example 2 was less than the thickness of the NiO layer in Comparative Example. Incidentally, in Table 1, the reason why the enlarged ratio was a negative value is presumed because the variation of the thickness of the NiO layer was high. Meanwhile, the enlargement ratio being a negative value or a value close to 0 suggests that the thickness of the NiO layer was scarcely increased by the spray drying method (influence of the variation>influence of the NiO layer increase). Also, from the results in Table 2 and FIGS. 4A and 4B, it was confirmed that the resistance value in Example 1 was less than that in Comparative Example.

### REFERENCE SIGNS LIST

1 . . . coated active material
2 . . . active material
3 . . . coating layer
4 . . . NiO layer
11, 21, 31 . . . slurry liquid droplet
12, 22, 32 . . . active material
13, 23, 33 . . . coating liquid

What is claimed is:

1. A coated active material comprising:
an active material including Ni, and
a coating layer configured to coat at least a part of a surface of the active material, and
a NiO layer is formed between the active material and the coating layer, and
an average thickness of the NiO layer is 0.9 nm or less.

2. The coated active material according to claim 1, wherein a maximum thickness of the NiO layer is 0.9 nm or less.

3. A coated active material comprising:
an active material including Ni, and
a coating layer configured to coat at least a part of a surface of the active material, and
a NiO layer is formed between the active material and the coating layer, and
a maximum thickness of the NiO layer is 0.9 nm or less.

4. The coated active material according to claim 1, wherein the active material is a lithium transition metal composite oxide including Ni.

5. The coated active material according to claim 1, wherein a content of Ni in the active material is 50 mol % or more with respect to a total of metal elements, excluding Li, included in the active material.

6. The coated active material according to claim 1, wherein the active material is Li(Ni_{α}Co_{β}Mn_{γ})O₂ or Li(Ni_{α}Co_{β}Al_{γ})O₂, wherein α, β, and γ satisfy 0.5≤α, 0<β, 0<γ, 0<β+γ≤0.5 and α+β+γ=1.

7. The coated active material according to claim 1, wherein the coating layer includes Nb.
